(19) United States
(12) Patent Application Publication
(10) Pub. No.: US 2020/0302797 A1
(43) Pub. Date: Sep. 24, 2020

(54) VEHICLE CONTROL APPARATUS AND METHOD

(71) Applicant: Honda Motor Co.,Ltd., Tokyo (JP)

(72) Inventor: Takayasu KUMANO, Saitama (JP)

(73) Assignee: Honda Motor Co.,Ltd., Tokyo (JP)

(21) Appl. No.: 16/361,234

(22) Filed: Mar. 22, 2019

(51) Int. Cl. G08G 1/16; B60W 30/095; B60W 40/04; B60W 50/14

(52) U.S. Cl. CPC G08G 1/167; B60W 50/14; B60W 40/04; B60W 30/0956

(57) ABSTRACT

A vehicle control apparatus and method are provided. The vehicle control apparatus comprises a surrounding detection part, detecting surrounding status of a host vehicle; and a control part, performing a moving control of the host vehicle according to the surrounding status. In a road system including a first road and a second road intersected with the first road that includes a first lane that is an innermost lane, a second lane that is an opposite lane of the first lane and a specified area arranged between the first and the second lanes, when the host vehicle enters the first lane, the control part determines whether the specified area or the first lane is set as a target position according to a traffic situation of the first lane.

### BACKGROUND

### Technical Field

The disclosure relates to a vehicle control apparatus and method for controlling a vehicle to enter a target area from a side road.

### Description of Related Art

The related art of Japanese Application Laid Open 2018-045482 discloses a method that when there is in a traffic jam the vehicle is guided to leave the main road from an exit that is not in a traffic jam. In addition, the method will provide a timing that the vehicle can join the traffic lane between traffic jams.

In addition, when entering the main road from a side road or a cross road, it is necessary to consider the issue of traffic jam. Therefore, the processor burden for the vehicle control is high, and the joint timing is limited. When turn across a road from a side road, it spent a lot of time to confirm the safety of the target lane and other lanes.

### SUMMARY

According to one embodiment of the disclosure, a vehicle control apparatus is provided. The vehicle control apparatus comprises a surrounding detection part, detecting surrounding status of a host vehicle; and a control part, performing a moving control of the host vehicle according to the surrounding status. In a road system including a first road and a second road intersected with the first road that includes a first lane that is an innermost lane, a second lane that is an opposite lane of the first lane and a specified area arranged between the first and the second lanes, when the host vehicle enters the first lane, the control part determines whether the specified area or the first lane is set as a target position according to a traffic situation of the first lane.

According to another embodiment of the disclosure, a vehicle control method, executed by a control part of a host vehicle, is provided. The vehicle control method comprises: detecting surrounding status of the host vehicle; performing a moving control of the host vehicle according to the surrounding status; in a road system including a first road and a second road intersected with the first road that includes a first lane that is an innermost lane, a second lane that is an opposite lane of the first lane and a specified area arranged between the first and the second lanes, when the host vehicle enters the first lane, determining whether the specified area or the first lane is set as a target position according to a traffic situation of the first lane.

### BRIEF DESCRIPTION OF THE DRAWINGS

FIG. 1 shows a schematic diagram of a vehicle control apparatus.

FIG. 2A shows an application scene of a cross road according to the disclosure.

FIG. 2B shows an application scene of a cross road according to the disclosure.

FIG. 3 is a flow chart showing a vehicle control method according to the embodiment of the disclosure.

FIGS. 4A and 4B show exemplary situation that the vehicle may directly make a left turn.

FIG. 5 shows a flow chart showing a detail vehicle control method according to the embodiment of the disclosure.

FIG. 6 shows a modified flow chart showing a vehicle control method according to the embodiment of the disclosure.

FIG. 7 shows another flow chart showing a detail vehicle control method according to another embodiment of the disclosure.

### DESCRIPTION OF THE EMBODIMENTS

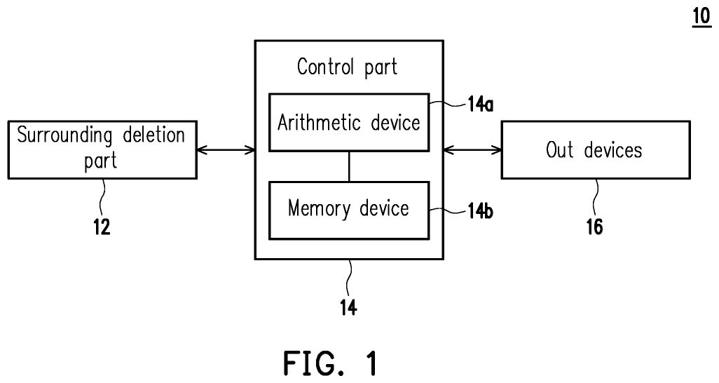

FIG. 1 shows a schematic diagram of a vehicle control apparatus. The vehicle control apparatus 10 of a vehicle (not shown) comprises at least a surrounding detection part 12 that detects surrounding status of the vehicle, and a control part 14 for performing a moving control of the vehicle. According to the surrounding status detected by the surrounding detection part 12, the control part 14 of the vehicle may perform various moving control to move the vehicle, such as steering, braking, accelerating, deaccelerating, etc. (also referring to output devices 16). In general, the control part 14 may be constructed by ECU, and include an arithmetic device 14a and a memory device 14b, for example. The memory device 14b may store various threshold values for example for comparison or determination in processing steps in addition to various programs executed by the arithmetic device 14a.

In general, the surrounding detection part 12 may include cameras mounted in the vehicle for capturing surrounding images (such as front images, rear images and side images), radars and LIDARs respectively detecting distances and relative speeds between the surrounding objects (other vehicles or static objects) and the vehicle. The vehicle also may include various sensors for sensing speed, acceleration, decelerating, moving distance, etc. of the vehicle 10. For those skilled in the art, the arrangement of these sensors, detecting components, and the like can be suitably modified based on the requirement. The disclosure only describes the at least required portion for making the description easy.

As known, there are two road system in the world, the right-hand traffic system such as America and the left-hand traffic system such as Japan. In the following embodiment, the right-hand traffic system is used as an example for explaining the disclosure, but not limited thereto. The concept, including the apparatus, the method or the corresponding programs, described in the disclosure can be also applied to the left-hand traffic system with a simple modification.

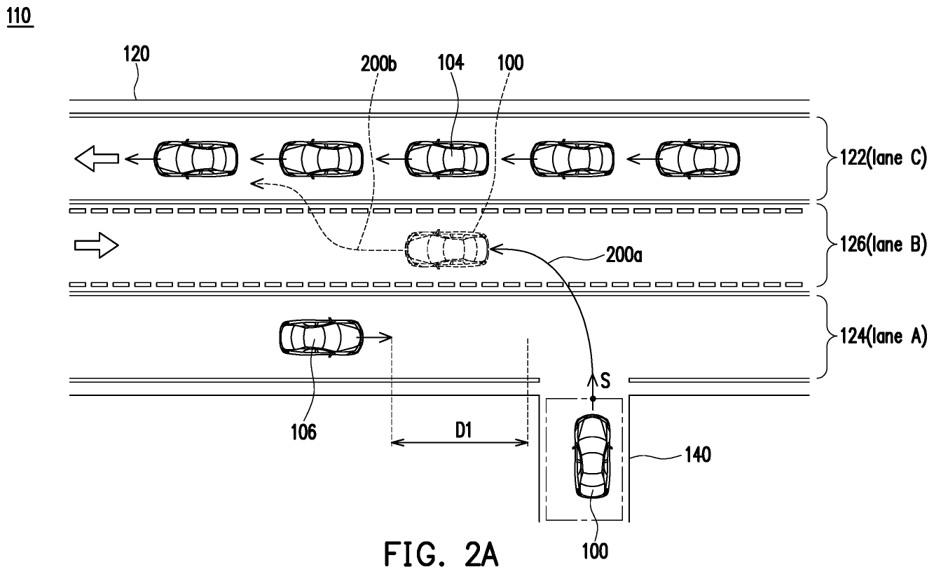

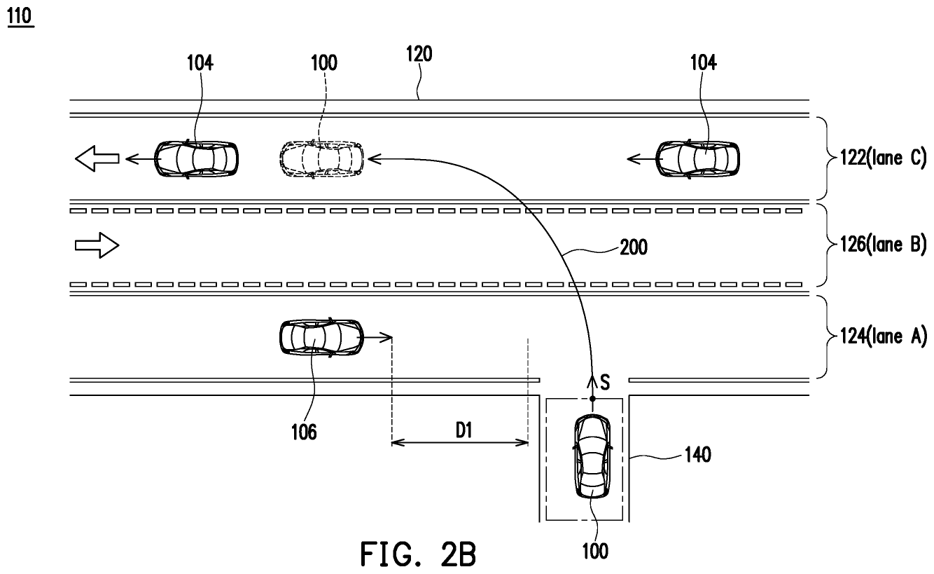

FIGS. 2A and 2B show assumption scenes of a road having a side road according to the disclosure. In FIGS. 2A and 2B, a road 110 includes a first road 120 and a second road 140 that may be a side road or a cross road intersected with the first road 120. The first road 120, which is left-right direction for example in this embodiment, may further include a first lane 122 and a second lane 124 with a moving direction opposite to the first lane 122, i.e., an opposite lane with respect to the first lane 122. In the embodiment, for easy description, the first lane 122, which is the final target lane and located away from the host vehicle 100 at the side road 140, refers to an innermost lane of the first road 110, and the second lane 124, which is in front of the host vehicle 100 at the side road 140, refers to an outermost lane.

Moreover, a specified area 126 is arranged between first lane 122 and the second lane 124. For example, the specified area 126 is a yellow lane, which is usually found in the American road system. The yellow lane 126 is a special lane designed for the vehicle to make a left turn to leave the main road, and the vehicle may only stay in the yellow lane 126 for a predetermined distance or time. According to the disclosure, when the vehicle tries to make a left turn and the target lane is in a traffic jam as shown in FIG. 2A for example, the vehicle is controlled to enter the yellow lane 126 first along the path 200a and wait to make a lane change to enter the first lane 122 along the path 200b at a suitable timing. In addition to the yellow lane, other special area, such as a zebra zone that can carry out the disclosure, can be used as the specified area 126.

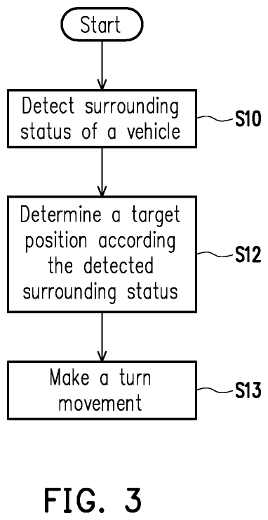

FIG. 3 is an outline flow chart showing a vehicle control method according to the embodiment of the disclosure. The concept of the disclosure is described first according to FIGS. 2A, 2B and 3. In addition, the process is performed on the premise that the specified area 124, i.e., the yellow lane, exists. As shown in FIG. 2A or 2B, at step S10 of FIG.3, when the host vehicle 100 prepare to turn left to enter the first lane 122 of the first road 120 from the second road 140 at the start point S, the surrounding detection part 12 of the host vehicle 100 starts detecting a surrounding status of the road 110, including the traffic situation of the first lane 122 and the second lane 124. For example, the surrounding detection part 12 will detect whether the first lane 122 is in a traffic jam or not, and whether there is a coming vehicle 106 in the second lane 124, etc.

At step S12, when the host vehicle 100 arrive the start point S and prepare to make a left turn, the control part 14 of the host vehicle 100 determines a target position according to the surrounding status detected by the surrounding detection part 12. Then, the control part 14 sets the specified area 126 or the first lane (i.e., the innermost lane) as the target position according to a traffic situation of the first lane 122. At step S13, the control part 14 of the host vehicle 100 performs a moving control of left turn to enter the determined target position. In other words, the disclosure utilizes the specified area 126 as a buffer area to make the host vehicle 100 move across the first road 120. When the traffic situation of the first lane 122 according to the surrounding status detected by the surrounding detection part 12 does not allow the host vehicle 100 to directly enter the first lane 122, the host vehicle 100 is controlled to make a left turn to enter the specified area 126 (the target position), i.e., the yellow lane along the path 200a as shown in FIG. 2A. In addition, when traffic situation of the first lane 122 according to the detected surrounding status allows the host vehicle 100 to enter the first lane 122, the host vehicle 100 is controlled to make a left turn to directly enter the first lane 122 (the target position) along the path 200 as shown in FIG. 2B.

In addition, according to the embodiment of the disclosure, the traffic volume, the speed of other vehicles 104 moving in the first lane 122 and the traffic jam, etc. may be used to determine the traffic situation of the first lane 122. For example, when the traffic volume, such as numbers of the vehicles 104 moving in the first lane 122 exceeds a predetermined value, it means the first lane 122 is not in a condition for the host vehicle 100 to enter and the specified area 126 is set as the target position. When the traffic volume of the first lane 122 is less than the predetermined value, the first lane 122 is set as the target position. Namely, when first lane 122 is not occupied by of the other vehicles 104, the traffic situation is determined to be good for directly making a left turn to enter the first lane 122. Otherwise, the host vehicle 100 will turn left to enter the specified area 126 and keeps moving in the specified area 126 for a while to prepare to make a lane change to enter the first lane 122 at a suitable timing.

In addition, when speeds of other vehicles 104 moving in the first lane 122 are less than a predetermined speed, the specified area 126 is set as the target position, and when the speeds of the other vehicles 104 moving in the first lane are equal to or larger than the predetermined speed, the first lane 122 is set as the target position. Accordingly, when the speeds of the other vehicles 104 detected by surrounding detection part 12 is determined to be low, it means the first lane 122 is occupied by of the other vehicles 104, the traffic situation is determined to be not good for directly making a left turn to enter the first lane 122. Then, the host vehicle 100 is controlled to enter the specified area 126, and keeps moving in the specified area 126 for a while to prepare to make a lane change to enter the first lane 122 at a suitable timing.

In addition, when the first lane 122 is in a traffic jam, the specified area 126 is set as the target position, and when the first lane 122 is not in a traffic jam, the first lane 122 is set as the target position. Namely, if the first lane 122 is in the traffic jam, the host vehicle 100 is controlled to enter the specified area 126, and keeps moving in the specified area 126 for a while to prepare to make a lane change to enter the first lane 122 at a suitable timing.

According to the above description, by using the specified area 126 (for example, the yellow lane), even though the traffic situation of the target lane, i.e., the first lane 122 is not in a condition for the host vehicle 100 to directly make a left turn to enter, the host vehicle 100 may enter the specified area 126 first and find a suitable timing to enter the target lane, i.e., the first lane 122. Therefore, the standby time for turning left to enter the target lane may be effective reduced.

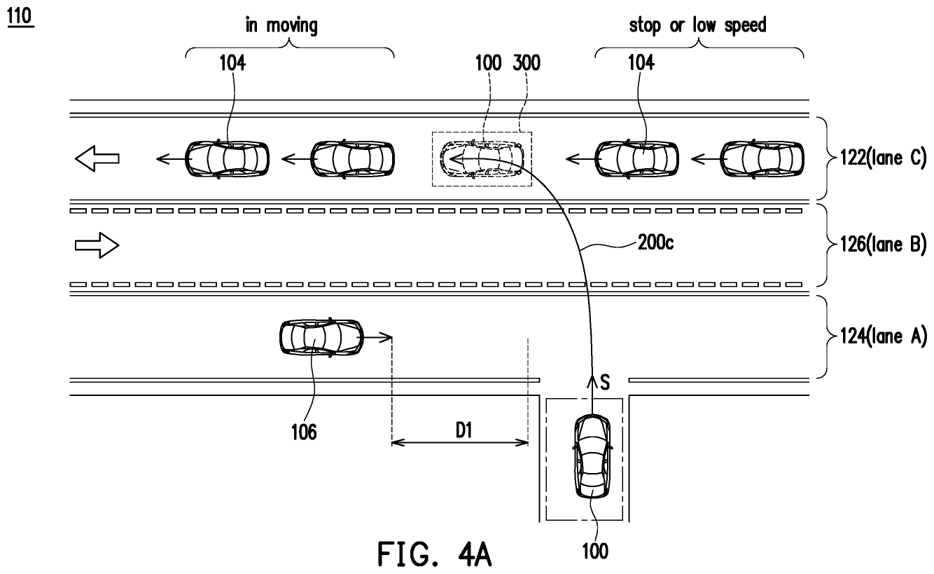

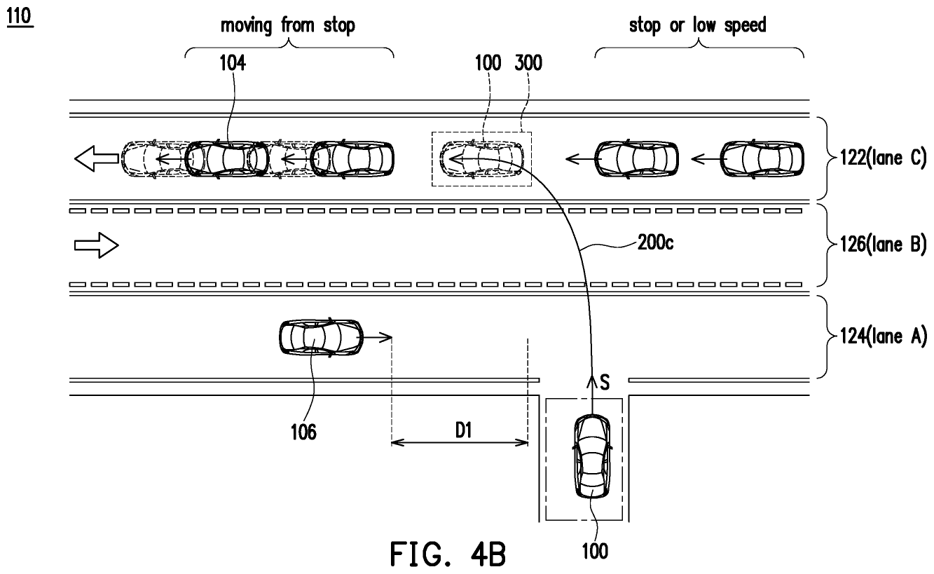

FIGS. 4A and 4B shows exemplary situation that the vehicle may directly make a turn. Usually, if the first lane 122 is occupied by a large number of other vehicles 104 and the speeds of the vehicles are low, the first lane 122 is considered as the traffic jam. At this time, the host vehicle 100 cannot directly make a left turn to the first lane 122. However, in some situations, although the first lane 122 is considered as the traffic jam, but the host vehicle 100 can still make a left turn to enter the first lane 122. The situation will be further described with reference with FIGS. 4A and 4B.

In FIG. 4A, the other vehicles 104 keep moving in the first lane 122, and the host vehicle 100 reaches the start point S and prepares to make a left turn. At a certain time, the traffic flow of the other vehicles 104 is split into two parts in front of the host vehicle 100 and an open area 300 is created between the two parts. When the other vehicles 104 behind the open area 300 decelerate or stop while the other vehicles 104 in front of the open area 300 keep moving, this means that the other vehicles 104 behind the open area 300 may intend yield the host vehicle 100 to enter the first lane 122 first. In this situation, when the surrounding detection part 12 detects the situation happened, and the host vehicle 100 is controlled to directly make a left turn along the path 200c to enter the open area 300 of the first lane 122.

In FIG. 4B, the vehicles 104 in the first lane 122 may stop due to some traffic situation, and the host vehicle 100 reaches the start point S and prepares to make a left turn. At a certain time, the traffic flow of the other vehicles 104 is split into two parts in front of the host vehicle 100 and an open area 300 is created between the two parts. When the other vehicles 104 in front of the open area 300 start moving from the stop status while the other vehicles 104 behind the open area 300 decelerate or stop while, this means that the other vehicles 104 behind the open area 300 may intend yield the host vehicle 100 to enter the first lane 122 first. In this situation, when the surrounding detection part 12 detects the situation happened, and the host vehicle 100 is controlled to directly make a left turn along the path 200c to enter the open area 300 of the first lane 122.

Accordingly, even though even though the traffic situation of the target lane, i.e., the first lane 122 is not in a condition for the host vehicle 100 to directly make a left turn to enter, but if the vehicles 104 behind the open area 300 intend yield the host vehicle 100 to enter the first lane 122, the host vehicle 100 may directly enter open area 300 of the first lane 122 without using the specified area 126. Once such situation is detected, the host vehicle 100 can quickly enter the first lane 122. Therefore, the standby time for turning left to enter the target lane may be effective reduced in some particular situations.

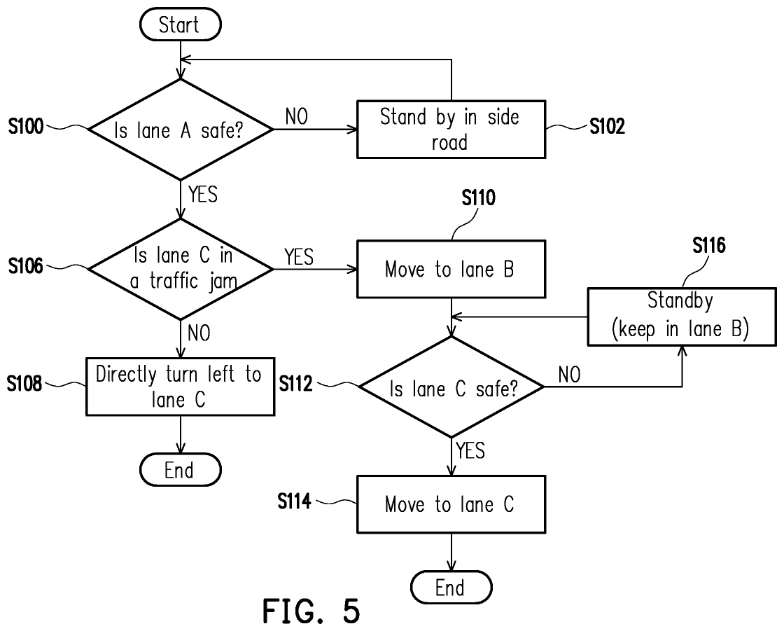

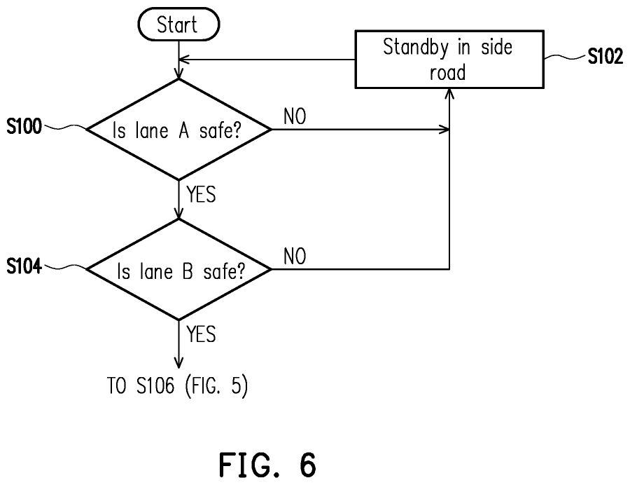

Next, the detail of the vehicle control method according to the disclosure is described with reference to FIG. 5. For simplicity, the second lane 124, the specified area 126 and the first lane 122 of the road 120 are respectively referred to lanes A, B and C.

Referring to FIGS. 2A, 2B and 5, first, the host vehicle 100 stops in the side road 140 at the start point S and prepares to turn left to enter the lane C. At step S100, the control process first determines whether the lane A is safe or not, i.e., confirms the traffic situation of the lane A. For example, the surrounding detection part 12 detects a safety distance D1 between the vehicle 106 and an intersection of the first road 120 and the second road 140, so as to determine whether there is enough safety distance D1 to make a left turn to the lane B or the lane C. When the detected distance between the other vehicle 106 and the intersection is less than the safety distance D1, i.e., the control process determines the lane A is not safe at step S100 (NO, step S100), and then moves to step S102. The control part 14 make the host vehicle 100 stop (on standby) and the control process moves to Step S100 again. In addition, the safety distance D1 may be predetermined in the control part 14 or other suitable components. In addition, the safety distance D1 between the other vehicle 106 and the intersection is variable and depends on a speed that the vehicle 106 moves in the lane A. Furthermore, in the case of the time to contact, it becomes the relative distance/the relative speed, so the speed of the other vehicle 106 has already been taken into consideration.

When the lane A is determined as safe at step S100, i.e., the detected distance between the other vehicle 106 and the host vehicle 100 is larger than or equal to the safety distance D1 (YES, stepS100), the control process moves to step S106 to determines whether the lane C is in a traffic jam or not. The determination of the traffic situation of the lane C may refer to the above description related to FIGS. 2A, 2B, 3 4A and 4B.

When the lane C is determined as being not in a traffic jam as shown in FIG. 2B (YES, step S106), the control process moves to step S108, and the control part 14 makes the host vehicle 100 to directly turn left from the side road 140 to enter the lane C, that is the host vehicle 100 is controlled to move along the path 200 from the start point S. Then, the control process of the vehicle control method is finished.

In addition, when the lane C is determined to be in the traffic jam at step S106 (YES, step S106), then the control process moves to step S110. At Step S110, the control part 14 makes the host vehicle 100 move to the lane B (the yellow lane in the embodiment) first. When the host vehicle 100 enters the lane B along the path 200a from the start point S, the host vehicle 100 temporally keeps in the lane B and the process moves to step S112. Then, the control process further determines whether the lane C is safe or not at step S112. At this time, the control part 14 of the host vehicle 100 that moves in the lane B will determine a suitable timing to make a lane change from the lane B to the lane C according to the traffic situation of the lane C detected by the surrounding detection part 12.

When the lane C is determined to be safe (YES, step S112), then the process moves to step S114 and the host vehicle 100 is controlled to move from the lane B to the lane C (lane change) along the path 200b. As the host vehicle 100 moves to the lane C, the control process is finished.

Similarly, when the lane C is determined to be not safe (NO, step S112), then the process moves to step S116. The host vehicle 100 keeps in the lane B and is on standby for entering the lane C. Then, the control process returns to step S112 again to determine whether the lane C is safe or not.

According to the aforementioned vehicle control method, when the vehicle turns left or right to enter the target lane from the side road or a cross road, the vehicle can enter the target lane by effectively using the specified area, for example the yellow lane, according to the traffic situation. As a result, the standby time of the vehicle at the side road or the cross road can be effectively reduced.

In addition, according to the aforementioned vehicle control method, when it determines that entering the target lane, i.e., the first lane (the innermost lane) directly is difficult due to the traffic situation for the host vehicle, the specified area is effectively used to reduce the time enter the target lane. Thus, the standby time for turning left or right to enter the target lane can be effectively reduced.

### Embodiment 2

FIG. 6 shows a modified flow chart showing a vehicle control method according to the embodiment of the disclosure. In FIG. 6, a step S 102 is further included to determine whether the lane B is safe or not. In the embodiment of the disclosure, an example of the specified area 126, i.e., the lane B, is a yellow lane.

As shown in FIG. 6, after the safety of the lane A is confirmed, the control process moves to step S104 to further determine whether the lane B is safe or not (YES, step S100). If the lane B is determined to be not safe, the process moves to step S102 and the host vehicle 100 stops at the second road (the side road) 140 and keeps on standby. Then, the control process moves again to steps S100 and S102 for safety confirmation of the lanes A and B.

When the lane B is determined to be safe at step S104, the control process moves to step S106 to determine the traffic situation of the lane C (YES, step S104). The followings steps and determinations are the same as those shown in FIG. 5, and thus their explanation is omitted. Moreover, FIG. 6 shows that the control process first performs the safety confirmation of the lane A and then the lane B, but the disclosure is not limited thereto. The sequence of the safety confirmation of the lanes A and B may be arbitrary, or performed simultaneously.

In this embodiment as described above, before the host vehicle 100 make a left turn, the safety confirmation of the lane B is further performed in addition to the safety confirmation of the lane A. Therefore, the safety of the vehicle control method can be further increased and improved. In addition to the aforementioned effect of reducing the standby time at the side road or the cross road, the safety for left (or right) turn can be further enhanced according to the embodiment.

### Embodiment 3

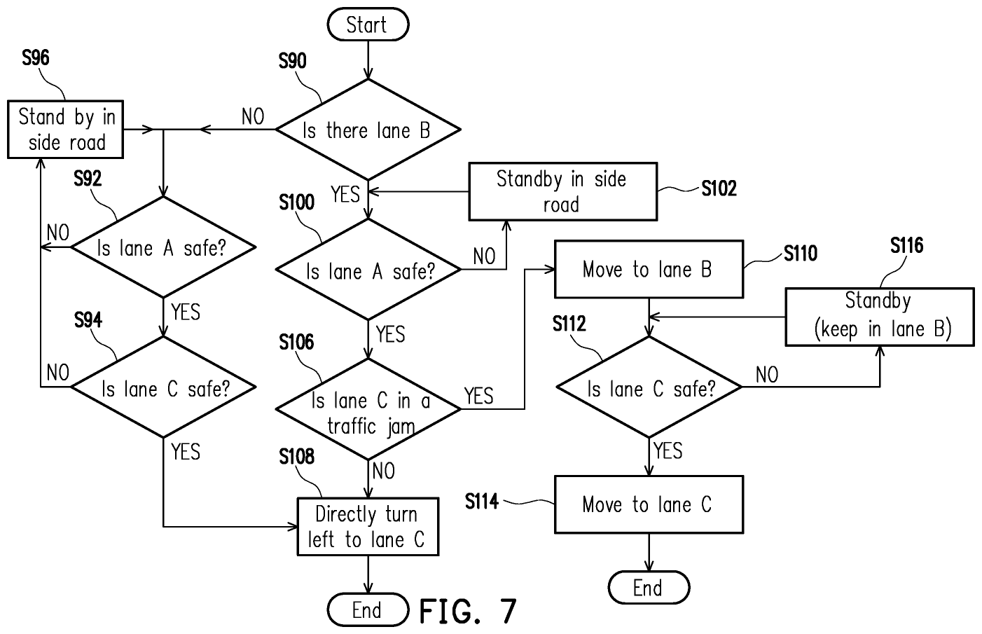

FIG. 7 shows another flow chart showing a vehicle control method according to another embodiment of the disclosure. In the embodiments 1 and 2, the vehicle control method is performed on the premise that the lane B, i.e., the yellow lane, exists. In the embodiment 3, the process further includes a step to determine whether there is the lane B or not.

As shown in FIG. 7, the control process determines whether there is a lane B, i.e., the yellow lane between two opposite lanes, i.e., the lanes A and C in FIG. 2A or 2B. When the process determines there is the lane B at step S90, the process moves to step S 100 to determine whether the lane A is safe or not (YES, step S90). Once the lane B exists, the following steps are the same as those shown in FIG. 5 and their corresponding explanation is omitted. Similarly, as described above, to determine whether the lane A is safe or not, the control part 14 of the host vehicle 100 will make decision at step S100 according to a safety distance D1 between the oncoming other vehicle 106 and the intersection of the first road 120 and the second road 140.

In addition, when the control process determines that the lane B does not exist at step S90, the process moves to step S92 to determine whether the lane A is safe or not (NO, step S90). When the lane A is determined to be safe, the control process moves to step S94 to further determine whether the lane C is safe or not (YES, step S92). At this time, if both the lanes A and C are determined to be safe, the control process moves to step S108 (YES, step S94) and the host vehicle 100 is controlled to directly turn left to the lane C. To determine whether the lane A is safe or not, the control part 14 of the host vehicle 100 will make decision at step S92 according to a safety distance D2 between the oncoming vehicle 106 and the intersection of the first road 120 and the second road 140.

In addition, according to the embodiment 3, the safety distance D1 for determining whether the lane A is safe at step S100 is different from the safety distance D2 for determining whether the lane A is safe at step S92. The safety distance between the coming vehicle 106 in the lane A and the intersection depends on whether the lane B, i.e., the yellow lane, exists or not. In general, the safety distance used for step S92 is less than the safety distance used in step S100. Namely, when there is the lane B, a longer safety distance D1 is required to determine whether the lane A is safe or not.

Accordingly, according to the embodiment, by further including a step of determining whether there is a specific lane (the yellow lane for example), the entire vehicle control method for making a left or right turn from a side road or a cross road can be more complete. Also, as described in the embodiment 1 or 2, the embodiment 3 may also effectively reduce the standby time of the vehicle at the side road or the cross road.

Others Configurations

According to the descriptions of the disclosure, followings configurations are provided. First, a vehicle control apparatus is provided. The vehicle control apparatus comprises a surrounding detection part, detecting surrounding status of a host vehicle; and a control part, performing a moving control of the host vehicle according to the surrounding status. When the host vehicle enters a first lane that is an innermost lane of a first road intersected with a second road where a specified area exists between the first lane and a second lane, the control part determines whether the specified area or the first lane is set as a target position according to a traffic situation of the first lane.

In the above vehicle control apparatus, when a traffic volume of the first lane exceeds a predetermined value, the control part sets the specified area as the target position. When the traffic volume of the first lane is less than the predetermined value, the control part sets the first lane as the target position.

In the above vehicle control apparatus, when speeds of other vehicles moving in the first lane are less than a predetermined speed, the control part sets the specified area as the target position. When the speeds of the other vehicles moving in the first lane are equal to or larger than the predetermined speed, the control part sets the first lane as the target position.

In the above vehicle control apparatus, when the innermost lane is in a traffic jam, the control part sets the specified area as the target position. When the first lane is not in a traffic jam, the control part sets the first lane as the target position.

In the above vehicle control apparatus, the control part further determines whether the specified area is safe for entering. In this manner, the safety confirmation can be further increased.

In the above vehicle control apparatus, in case of a plurality of other vehicles moving in the first lane, a first portion of the plurality of the other vehicles pulls apart from a second portion of the plurality of the other vehicles to form an open area in front of the host vehicle, when the second portion of the plurality of the other vehicles behind the open area stops or decelerates to be lower than speeds of the first portion of the plurality of the other vehicles beyond the open area, the first lane is set as the target position.

In the above vehicle control apparatus, in case of a plurality of other vehicles stops in the first lane, a first portion of the plurality of the other vehicles start moving to pull apart from a second other portion of the plurality of the other vehicles to form an open area in front of the vehicle, when the second portion of the plurality of the other vehicles behind the open area still stops or moves with speeds lower than seeds of the first portion of the plurality of the other vehicles beyond the open area, the first lane is set as the target position.

According to another embodiment of the disclosure, a vehicle control method, executed by a control part of a host vehicle, is provided. The vehicle control method comprises: detecting surrounding status of the host vehicle; performing a moving control of the host vehicle according to the surrounding status; when the host vehicle enters a first lane that is an innermost lane of a first road intersected with a second road where a specified area is arranged between the first lane and a second lane, determining whether the specified area or the first lane is set as a target position according to a traffic situation of the first lane.

In the above vehicle control method, the method further comprises: when a traffic volume of the first lane exceeds a predetermined value, setting the specified area as the target position; and when the traffic volume of the first lane is less than the predetermined value, setting the first lane as the target position.

In the above vehicle control method, the method further comprises: when speeds of other vehicles moving in the first lane are less than a predetermined speed, setting the specified area as the target position; and when the speeds of the other vehicles moving in the first lane are equal to or larger than the predetermined speed, setting the first lane as the target position.

In the above vehicle control method, the method further comprises: when the first lane is in a traffic jam, setting the specified area as the target position; and when the first lane is not in a traffic jam, setting the first lane as the target position.

In the above vehicle control method, the method further determines whether the specified area is safe for entering. In this manner, the safety confirmation can be further increased.

In the above vehicle control method, in case of a plurality of other vehicles moving in the first lane, a first portion of the plurality of the other vehicles pulls apart from a second portion of the plurality of the other vehicles so as to form an open area in front of the host vehicle, the method further comprises: when the second portion of the plurality of the other vehicles behind the open area stops or decelerates to be lower than speeds of the first portion of the plurality of the other vehicles beyond the open area, setting the first lane as the target position.

In the above vehicle control method, in case of a plurality of other vehicles stops in the first lane, a first portion of the plurality of the other vehicles start moving to pull apart from a second portion of the plurality of the other vehicles so as to form an open area in front of the host vehicle, the method further comprises: when the second portion of the plurality of the other vehicles behind the open area still stops or moves with speeds lower than speed of the first portion of the plurality of the other vehicles beyond the open area, setting the first lane as the target position.

In the above configuration, by using the specified area (for example, the yellow lane), even though the traffic situation of the first lane is not in a condition for the host vehicle to directly make a left turn to enter, the host vehicle may enter the specified area first and find a suitable timing to enter the target lane, i.e., the first lane. Therefore, the standby time for turning left to enter the target lane may be effective reduced.

In the above configurations, even though even though the traffic situation of the target lane is not in a condition for the host vehicle to directly make a left turn to enter, but if the other vehicles behind the open area intend yield the host vehicle to enter the first lane, the host vehicle may directly enter open area of the first lane without using the specified area. Once such situation is detected, the vehicle can quickly enter the first lane. Therefore, the standby time for turning left to enter the target lane may be effective reduced in some particular situations.

In the above vehicle control apparatus or method, the specified area is a yellow line, which is usually found in the American road system, or a zebra zone. In the above configurations, by using the special lane or zone, it is more effective and saves time to turn across a road from a side road.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A vehicle control apparatus, comprising:
a surrounding detection part, detecting surrounding status of a host vehicle; and
a control part, performing a moving control of the host vehicle according to the surrounding status,
wherein in a road system including a first road and a second road intersected with the first road that includes a first lane that is an innermost lane, a second lane that is an opposite lane of the first lane and a specified area arranged between the first and the second lanes, when the host vehicle enters the first lane, the control part determines whether the specified area or the first lane is set as a target position according to a traffic situation of the first lane.

2. The vehicle control apparatus according to claim 1, wherein when a traffic volume of the first lane exceeds a predetermined value, the specified area is set as the target position, and
when the traffic volume of the first lane is less than the predetermined value, the first lane is set as the target position.

3. The vehicle control apparatus according to claim 1, wherein when speeds of other vehicles moving in the first lane are less than a predetermined speed, the specified area is set as the target position, and
when the speeds of the other vehicles moving in the first lane are equal to or larger than the predetermined speed, the first lane is set as the target position.

4. The vehicle control apparatus according to claim 1, wherein when the first lane is in a traffic jam, the specified area is set as the target position, and
when the first lane is not in a traffic jam, the first lane is set as the target position.

5. The vehicle control apparatus according to claim 1, wherein the control part determines whether the specified area is safe for entering.

6. The vehicle control apparatus according to claim 1, wherein in case of a plurality of other vehicles moving in the first lane, a first portion of the plurality of the other vehicles pulls apart from a second portion of the plurality of the other vehicles so as to form an open area in front of the host vehicle,
when the second portion of the plurality of the other vehicles behind the open area stops or decelerates to be lower than speeds of the first portion of the plurality of the other vehicles beyond the open area, the first lane is set as the target position.

7. The vehicle control apparatus according to claim 1, wherein in case of a plurality of other vehicles stops in the first lane, a first portion of the plurality of the other vehicles start moving to pull apart from a second portion of the plurality of the other vehicles so as to form an open area in front of the host vehicle,
when the second portion of the plurality of the other vehicles behind the open area still stops or moves with speeds lower than speed of the first portion of the plurality of the other vehicles beyond the open area, the first lane is set as the target position.

8. The vehicle control apparatus according to claim 1, wherein when the specified area is a yellow line.

9. A vehicle control method, executed by a control part of a host vehicle, the vehicle control method comprising:
detecting surrounding status of the host vehicle;
performing a moving control of the host vehicle according to the surrounding status;
when in a road system including a first road and a second road intersected with the first road that includes a first lane that is an innermost lane, a second lane that is an opposite lane of the first lane and a specified area arranged between the first and the second lanes, when the host vehicle enters the first lane, determining whether the specified area or the first lane is set as a target position according to a traffic situation of the first lane.

10. The vehicle control method according to claim 8, further comprising:
when a traffic volume of the first lane exceeds a predetermined value, setting the specified area as the target position; and
when the traffic volume of the first lane is less than the predetermined value, setting the first lane as the target position.

11. The vehicle control method according to claim 9, further comprising
when speeds of other vehicles moving in the first lane are less than a predetermined speed, setting the specified area as the target position; and
when the speeds of the other vehicles moving in the first lane are equal to or larger than the predetermined speed, setting the first lane as the target position.

12. The vehicle control method according to claim 9, further comprising:
when the first lane is in a traffic jam, setting the specified area as the target position; and
when the first lane is not in a traffic jam, setting the first lane as the target position.

13. The vehicle control method according to claim 9, further comprising: determining whether the specified area is safe for entering.

14. The vehicle control method according to claim 9, wherein in case of a plurality of other vehicles moving in the first lane, a first portion of the plurality of the other vehicles pulls apart from a second portion of the plurality of the other vehicles so as to form an open area in front of the host vehicle,
when the second portion of the plurality of the other vehicles behind the open area stops or decelerates to be lower than speeds of the first portion of the plurality of the other vehicles beyond the open area, setting the first lane as the target position.

15. The vehicle control method according to claim 9, wherein in case of a plurality of other vehicles stops in the first lane, a first portion of the plurality of the other vehicles start moving to pull apart from a second portion of the plurality of the other vehicles so as to form an open area in front of the host vehicle,
when the second portion of the plurality of the other vehicles behind the open area still stops or moves with speeds lower than speed of the first portion of the plurality of the other vehicles beyond the open area, setting the first lane as the target position.

16. The vehicle control method according to claim 9, wherein when the specified area is a yellow line.
